(19) United States
(12) Patent Application Publication
(10) Pub. No.: US 2016/0264815 A1
(43) Pub. Date: Sep. 15, 2016

(54) AQUEOUS COATING COMPOSITION AND PRODUCTION OF TOPCOATS USING THE COATING COMPOSITION

(71) Applicant: BASF COATINGS GMBH, Münster (DE)

(72) Inventors: Frank JOEGE, Sendenhorst (DE); Margarete ROHLMANN, Muenster (DE); Edmund HESS, Laer (DE)

(73) Assignee: BASF COATINGS GMBH, Muenster (DE)

(21) Appl. No.: 15/029,514

(22) PCT Filed: Aug. 21, 2014
(86) PCT No.: PCT/EP2014/067811

§ 371 Date: Apr. 14, 2016

(30) Foreign Application Priority Data
Oct. 16, 2013 (EP) 13188851.3

(51) Int. Cl. C09D 167/02; B65D 65/42; C23C 26/00; B05D 7/14; B05D 3/04

(52) U.S. Cl. CPC C09D 167/02; B05D 7/14; B05D 3/0473; C23C 26/00; B65D 65/42; B05D 7/50

(57) ABSTRACT

The present invention relates to an aqueous coating composition comprising at least one first polymer (A) as binder, at least one crosslinking agent (B) and at least one copolymer (C) as second binder, which is obtainable by copolymerization of ethylenically unsaturated monomers in the presence of a polyurethane resin having polymerizable carbon double bonds, the weight ratio of polymer (A) to polymer (C) being greater than 3.0. The present invention further relates to a method for producing a topcoat on a metallic substrate that comprises applying and subsequently curing the coating composition of the invention on a metallic substrate, and also to a metallic substrate coated by the method of the invention.

The present invention relates to an aqueous coating composition comprising a first polymer (A) as binder, a crosslinking agent (B), and a polymer (C), different from the polymer (A), as second binder, obtainable by copolymerization of ethylenically unsaturated monomers in the presence of a polyurethane resin having polymerizable carbon double bonds. The present invention further relates to a process for preparing the aqueous coating composition and also to a method for producing a topcoat on a metallic substrate using the aqueous coating composition. The present invention relates not least to a coated metallic substrate which has been coated by the method of the invention for producing a topcoat. Metallic substrates to be coated are, for the purposes of the present invention, especially packaging, in other words packaging containers, more particularly food packaging.

### PRIOR ART

Metallic packaging containers, examples being cans such as beverage cans and preserve cans, tubes, canisters, pails, and the like, generally have coating systems on their outer face, serving for example for decorative design, for corrosion prevention and for protection from mechanical exposure of the packaging containers.

In addition to conventional multicoat systems comprising a base varnish or stamping varnish as decoration carrier, a printing-ink coating, and a transparent topcoat, referred to as the silver lacquer, coating systems with which there is no need for a final transparent topcoat are coming ever more into the foreground. The attendant simplification of the production process, and the saving in terms of material, are sufficient reason for development of coating systems of these kinds. These coating compositions, also referred to as “non-varnish outer coatings”, are therefore required not only to exhibit certain requirements in terms of decorative properties, such as coloring, and to exhibit high printability by printing inks, but are required additionally to fulfill ideally the functions which are actually those of the silver lacquer. These special outer coatings, indeed, then themselves constitute the topcoat, in other words the outermost coat of a coating system. All that is then applied to this topcoat is only, optionally, a printing ink for the application of an indicium or the like. As far as the functions to be achieved are concerned, high abrasion resistance deserves particular mention, since the packaging containers, such as cans more particularly, are exposed to high mechanical loading in the context, for example, of storage and transport and of the friction with one another that is unavoidable during such transport and storage. Other properties are good printability and also a smooth surface structure, more particularly the avoidance of finishing defects such as pop marks, and a high gloss.

Another key challenge which arises in connection with the production of such varnish coatings on the outside of metallic packaging materials is that the varnish systems, or the coating compositions used for varnishing, must be selected such that as well as the properties already stated they also withstand the stresses, in some cases massive, during the production procedure.

In the context of industrial processes for producing varnished and printed metallic packaging containers, such as beverage cans, for example, the general approach is to varnish the packaging container after it has already been shaped, and especially not to varnish a still planar metal substrate or metal coil which is not shaped to completion until later. Following the varnishing operation, the only operation that remains is that of fine shaping. In this latter operation, the shaped body is subjected to beading and/or necking, for the purpose, for example, of increasing stability and/or saving on material. In this way, for example, interior and exterior varnishing may take place individually, alongside application of printing inks to the outside of the container.

The procedure here is frequently to first apply a “non-varnish outer coating” as described above and to expose this coating in an oven only to conditions such that there is in particular as yet no fully cured coating film produced. The temperatures and/or times in the first oven phase, therefore, are not sufficient for complete curing and/or final crosslinking of the coating.

The reason for this is, for example, that the printing ink applied subsequently is able in this way to adhere more effectively to the varnish system. Indeed, in the case of incomplete curing and hence of as yet not very high crosslinking density on the part of the varnish system, the printing ink is firstly able still to migrate into this varnish film. Secondly it is possible, if the printing ink likewise comprises typical polymers, also described later on below, with functional groups for crosslinking, these groups react with as yet uncrosslinked, complementary functional groups in the varnish film. These processes thus lead obviously to improved adhesion of the printing ink.

Another reason for the incomplete separate curing of the outer coating lies in the nowadays increasingly important energy balance of the production process. Since further films that require curing, such as the printing-ink film and the interior varnish system, are applied after the outer varnish system has been produced, it is of course an advantage to utilize the energy that is required anyway for these films, for curing, for the outer varnish system as well.

It must be borne in mind here, however, that incomplete curing in the first oven phase, and hence only low crosslinking density on the part of the outer varnish, is generally attended by only very low abrasion resistance on the part of the varnish system in question. A problem then is that in the case of the industrial process regime, it is unavoidable for the cans, when being passed onward from the first oven to the printing station and to the interior varnishing station, to be subject to a certain mechanical stress, more particularly a friction, with one another. This may be accompanied by unacceptable damage to the outer varnish system.

DE 196 37 970 A1 discloses a coating material for the coating of packaging containers, where the coating material builds up a single-coat outer varnish system on said containers. The coating material comprises a combination of a hydroxy-functional polyester and a water-thinnable, modified epoxy resin ester. The technological properties achieved in the fully cured varnish system, in terms of flow, printability, and abrasion resistance, for example, are acceptable. The abrasion resistance of the outer varnish system without complete curing is in need of improvement; the underlying problem is not addressed and was not recognized.

WO 91/15528 discloses an aqueous basecoat material for constructing multicoat paint systems on automobile bodies, said systems comprising the basecoat plus a clearcoat finish applied to said basecoat. The principal binder of the basecoat is a polymer obtainable by copolymerization of ethylenically unsaturated monomers in the presence of a polyurethane resin having polymerizable carbon double bonds. An example of a feature of the basecoat material is that after just a short time it can be recoated with an aqueous or conventional clearcoat material in a wet-on-wet process without disruption to the basecoat film. There is no reference to the technical field of the coating of packaging containers.

An advantage would be a coating composition which no longer has the disadvantages of the prior art but which instead can be used ideally as an outer varnish or topcoat varnish for the varnishing of packaging containers, and which results in particular in increased abrasion resistance of the varnish system in question, in spite of an incomplete, separate baking or curing operation on this outer varnish material. In this context it is of course not necessary for the abrasion resistance to be of the same order of magnitude as that of a varnish system that has actually been cured fully. What is important, instead, is a significant improvement in the abrasion resistance, in relation to the very low abrasion resistances of incompletely cured varnish systems of the prior art, in order thereby to be able to meet the mechanical requirements during the production operation that have been described above and which, while not being excessive, nevertheless do exist. At the same time, the coating material ought to be aqueous in character, in order to do justice to the present-day requirements concerning the environmental profile of a coating material.

### Problem and Solution

A problem addressed by the present invention, accordingly, was that of providing an aqueous coating composition which in comparison to the known coating compositions, when used for producing topcoat films on metallic substrates, more particularly packaging containers, exhibits improved abrasion resistance of these topcoat films, and more particularly of topcoat films that are not yet fully cured. The intention in this way was to provide a coating composition which in particular meets the mechanical requirements associated with the production of packaging container products.

The stated problems have been solved by an aqueous coating composition comprising

(A) at least one polymer as first binder,

(B) at least one crosslinking agent, and

(C) at least one copolymer as second binder, obtainable by copolymerization of ethylenically unsaturated monomers in the presence of a polyurethane resin having polymerizable carbon double bonds,

and wherein

the weight ratio of polymer (A) to polymer (C) is greater than 3.0.

The new coating composition is also referred to below as coating composition of the invention. Preferred embodiments of the coating material of the invention are evident from the dependent claims and from the description which follows.

Further provided by the present invention is a method for producing a topcoat on a metallic substrate, using the coating composition of the invention, said method comprising the application and subsequent curing of the coating composition of the invention on an optionally primed metallic substrate.

The present invention relates, moreover, to a topcoat produced in accordance with the method of the invention, and also to a metallic substrate coated in accordance with the method of the invention.

The new coating composition, and the topcoat system produced from it, and the substrate coated with a topcoat of this kind, display excellent properties in terms of abrasion resistance, particularly in the case of the as yet not fully cured coating system.

### DETAILED DESCRIPTION

The coating composition of the invention comprises at least one polymer (A) as binder.

Suitable polymers (A) as binders are, for example, (co)polymers of ethylenically unsaturated monomers, or polyaddition resins and/or polycondensation resins, that are of random, alternating and/or blockwise construction and are of linear and/or branched and/or comb construction. Regarding these terms, supplementary reference is made to Rompp Lexikon Lacke and Druckfarben, Georg Thieme Verlag, Stuttgart, New York, 1998, page 457, “polyaddition” and “polyaddition resins (polyadducts)”, and also pages 463 and 464, “polycondensates”, “polycondensation”, and “polycondensation resins”, and also pages 73 and 74, “binders”.

Examples of suitable (co)polymers are (meth)acrylate (co)polymers or partially hydrolyzed polyvinyl esters, more particularly (meth)acrylate copolymers. Examples of suitable polyaddition resins and/or polycondensation resins are polyesters, alkyds, polyurethanes, polylactones, polycarbonates, polyethers, epoxy resins, epoxy resin-amine adducts, polyureas, polyamides, polyimides, polyester-polyurethanes, polyether-polyurethanes, or polyester-polyether-polyurethanes.

The polymers (A) as binders preferably comprise thio, hydroxyl, N-methylolamino-N-alkoxymethylamino, imino, carbamate, allophanate and/or carboxyl groups, preferably hydroxyl groups and/or carboxyl groups. By way of these functional groups, more particularly hydroxyl and carboxyl groups, it is then possible for crosslinking to take place, for example, with components which comprise further functional groups, such as, preferably, anhydride, carboxyl, epoxy, blocked isocyanate, urethane, methylol, methylol ether, siloxane, carbonate, amino, hydroxyl and/or beta-hydroxyalkylamide groups.

With particular preference the coating composition comprises a hydroxy-functional polymer (A) as binder, more preferably a hydroxy-functional polyester. Especially preferred is a polyester containing hydroxyl groups and carboxyl groups. It is therefore the case that the coating composition in any case, but not necessarily exclusively, includes such a polyester (A) as binder.

It is especially preferred here for the at least one polymer (A), as binder, to be able via the functional groups, more particularly by the above-described functional groups, preferably hydroxyl groups, very preferably hydroxyl and carboxyl groups, to enter into crosslinking with at least one crosslinking agent (B), also described later on below, and comprising corresponding, complementary functional groups, examples being melamine resins, a cured coating film then being formed as a result.

This means, therefore, that the coating composition of the invention is in particular curable thermally—that is, by chemical reaction of reactive functional groups as described above, it is possible for crosslinking to take place (formation of a coating film), the energetic activation of this chemical reaction being possible by thermal energy. In this context it is preferably externally crosslinking, meaning that the reactive functional groups complementary to one another are present in different components, more particularly in polymers as binders and in crosslinking agents.

For the purposes of the present invention, the terms “binder” and “crosslinking agent” are used for better understanding and/or for improved ability to differentiate. Both terms are known to the skilled person and are consequently clarifying in their character. In principle, in the case of the externally crosslinking thermal curing of a coating composition, there is crosslinking between the functional groups of a polymer as binder and the therefore complementary functional groups of the crosslinking agent. Typical combinations of polymers as binder and crosslinking agents are, for example, hydroxy- and/or carboxy-functional polymers as binder, and polyisocyanates and/or amino resins, more particularly melamine resins and benzoguanamine resins, in other words, therefore, adducts containing methylol groups and/or methylol ether groups, or polycarbodiimides, as crosslinking agents.

Not ruled out by the above, of course, is that the coating material, proportionally, for example, is also self-crosslinking—that is, the complementary reactive functional groups are already present in one and the same polymer used as binder and/or in the crosslinking agent that is used. Such proportional self-crosslinking also occurs in particular in the case of components which comprise methylol groups, methylol ether groups and/or N-alkoxymethylamino groups—that is, for example, in the case of the melamine resins as described with greater precision later on below.

Other curing mechanisms as well, such as a proportional physical curing (that is, the curing of a layer of a coating composition by filming, through loss of solvent from the coating composition, with the linking taking place within the coating via looping of the polymer molecules), for example, are of course not ruled out.

It is nevertheless preferred for the coating composition to be at any rate externally crosslinking, through the use of a hydroxy-functional polymer (A) as binder, especially preferably a hydroxy- and carboxy-functional polymer, preferably a corresponding polyester, in addition to a crosslinking agent as described below.

The polyesters that are suitable preferentially as polymers (A) and are preferred in the context of the present invention may be saturated or unsaturated, more particularly saturated. Polyesters and their preparation, and also the components that can be used for such preparation, are known to the skilled person.

The polymers in question are more particularly polymers which are prepared using polyhydric organic polyols and polybasic organic carboxylic acids. These polyols and polycarboxylic acids are linked with one another by esterification, in other words, therefore, by condensation reactions. The polyesters, accordingly, are generally assigned to the group of polycondensation resins. Depending on the nature, functionality, and fractions and proportions of the starting components that are employed, the resulting products are, for example, linear or branched. While linear products are formed primarily with use of difunctional starting components (diols, dicarboxylic acids), the use of alcohols with higher functionality (OH functionality, in other words number of OH groups per molecule, greater than 2), for example, produces branching. Also possible for the preparation, of course, is the proportional use of monofunctional components, examples being monocarboxylic acids. To prepare polyesters it is also possible, as is known, to employ—rather than or as well as the corresponding organic carboxylic acids—the anhydrides of the carboxylic acids, more particularly the anhydrides of the dicarboxylic acids. Likewise possible is preparation through the use of hydroxycarboxylic acids or of the lactones derived from the hydroxycarboxylic acids by intramolecular esterification.

Examples of suitable diols are glycols, such as ethylene glycol, propylene glycol, butylene glycol, butane-1,4-diol, hexane-1,6-diol, neopentyl glycol, and other diols, such as 1,4-dimethylolcyclohexane or 2-butyl-2-ethyl-1,3-propanediol. Suitable alcohols with higher functionality (OH functionality greater than 2) are, for example, trimethylolpropane, glycerol, and pentaerythritol.

The acid component of a polyester generally comprises dicarboxylic acids or their anhydrides having 2 to 44, preferably 4 to 36, carbon atoms in the molecule. Examples of suitable acids are o-phthalic acid, isophthalic acid, trephthalic acid, tetrahydrophthalic acid, cyclohexanedicarboxylic acid, succinic acid, adipic acid, azelaic acid, sebacic acid, maleic acid, fumaric acid, glutaric acid, hexachloroheptanedicarboxylic acid, tetrachlorophthalic acid and/or dimerized fatty acids. In place of these acids it is also possible to use their anhydrides, where they exist. Use may also be made of carboxylic acids of higher functionality, having 3 or more carboxyl groups (and/or the corresponding anhydrides), an example being trimellitic anhydride. Use is also made frequently, proportionally, of monocarboxylic acids, such as unsaturated fatty acids, for example.

Examples of hydroxycarboxyilc acids which can be used are hydroxycaproic acid, hydroxybutyric acid, hydroxydecanoic acid and/or 12-hydroxystearic acid. Examples of lactones which can be used are the beta-, gamma-, delta-, and epsilon-lactones that are known per se, more particularly epsilon-caprolactone.

Besides the monomeric compounds described above it is also possible, for example, to use starting products that are already polymeric—as diols, for example, the polyester diols which are known per se and are obtained by reaction of a lactone with a dihydric alcohol.

The polymers (A) as binders, more particularly the polyesters, possess an OH number preferably of 50 to 250 mg KOH/g, more preferably 70 to 200 mg KOH/g, and more particularly 90 to 150 mg KOH/g. In the context of the present invention, the OH number is measured in accordance with DIN 53240. Where reference is made in the context of the present invention to an official standard, the reference of course is to the version of the standard that was valid on the date of filing or, if there was no valid version at that time, the most recent valid version.

The coating composition of the invention is aqueous (with regard to the description of “aqueous”, see below). Accordingly, the polymers (A) as binders, more particularly the polyesters, are preferably polymers dispersible or soluble in water. As the skilled person is aware, this means that the polymers, in at least proportionally aqueous media, do not precipitate as insoluble agglomerates, but instead form a solution or a fine dispersion. For this purpose, generally, as is known, it is advantageous, or even necessary, to introduce potentially ionic groups, more particularly potentially anionic groups, preferably carboxyl groups. Such groups are incorporated into the polymer more particularly through corresponding monomers employed during the preparation, with the completed polymer then comprising these groups. This procedure can be made even more effective, as is known, through specific neutralization of groups capable of forming anions, more particularly of carboxyl groups. This means, therefore, that these groups are neutralized, for example, during the preparation of the polymers and/or during the preparation of the coating composition, with neutralizing agents, preferably ammonia, amines and/or, in particular, amino alcohols. Used by way of example for the neutralization are di- and triethylamine, dimethylaminoethanol, diisopropanolamine, morpholines and/or N-alkylmorpholines.

The detail “dispersible or soluble in water” does not mean that the respective polymer (A) also has to be used in a form present in aqueous solution or in aqueous dispersion in the coating composition of the invention. The polymer can, for example, also be prepared in organic solvents or acquired commercially as a dispersion in organic solvents, and used in this way in the coating composition of the invention. Water is also then added on subsequent mixing with the further constituents of the coating composition, producing the aqueous character described in more detail below.

The at least one polymer (A), preferably the polyester, therefore preferably has an acid number of 10 to 100 mg KOH/g, preferably 20 to 60 mg KOH/g. The acid number in the context of the present invention is measured in accordance with DIN EN ISO 3682. Following the application of the coating composition of the invention, the carboxylic acid groups that are preferably present may, of course, also serve for crosslinking with crosslinking agents, more particularly melamine resins and benzoguanamine resins, and so make a contribution to the formation of a crosslinked coating film.

Suitable polymers (A) as binders, more particularly the polyesters, have for example a number-average molecular weight of 500 to 5000 g/mol, preferably 600 to 2000 g/mol. The weight-average molecular weight is situated, for example, in the range from 1000 to 10 000 g/mol, preferably 1500 to 5000 g/mol. The molecular weights are determined, for the purposes of the present invention, by means of GPC analysis with THF (+0.1% acetic acid) as eluent (1 ml/min) on a styrene-divinylbenzene column combination. Calibration is carried out using polystyrene standards.

The amount of polymers (A) as binders is preferably 5 to 35 wt %, especially preferably 7 to 33 wt %, very preferably 10 to 30 wt %, and, in one particular embodiment, 15 to 25 wt %, based in each case on the total amount of the coating composition of the invention. In the context of the present invention it is preferred for a polyester (A) as described above, preferably a hydroxy- and carboxy-functional polyester as binder, to make up at least 80 wt %, more particularly 85 to 95 wt %, of the polymers (A) employed as binders.

The fraction of the polymers (A) or of a particular polymer (A) is determined as follows: The solids content of a binder dispersion of a polymer (A) which is to be added to the coating composition is ascertained. Taking account of the solids content of the binder dispersion and of the amount of dispersion that is used in the coating composition, it is then possible to determine or specify the fraction of the polymer (A) as a proportion of the overall composition.

For the purposes of the present invention, unless otherwise indicated, the solids content is determined in accordance with DIN EN ISO 3251 with an initial mass of 1.0 g of sample, as for example 1.0 g of the coating material of the invention, with a test duration of 60 minutes and with a temperature of 125° C.

The coating composition of the invention comprises at least one crosslinking agent (B).

Crosslinking agents and their use in coating compositions are known to the skilled person. They are in principle components which have reactive functional groups which are complementary to the reactive functional groups of polymers used, for example, as binders, such as the polymers (A) or else the polymers (C) described below, for example, and which, accordingly, are able to effect chemical crosslinking.

Used with preference in the context of the present invention are crosslinking agents selected from the group consisting of polyisocyanates, amino resins, more particularly melamine resins and benzoguanamine resins, and also polycarbodiimides.

Such crosslinking agents comprise isocyanate groups and/or methylol, methylol ether and/or N-alkoxymethylamino groups, and also carbodiimide groups as reactive functional groups, which are able as described above to crosslink with reactive functional groups of further components, more particularly with the at least one polymer (A) as binder, preferably with a hydroxy- and carboxy-containing polymer (A).

Polyisocyanates which can be used are, in particular, the polyisocyanates known in this context to the skilled person, such as, for example, hexamethylene diisocyanate, octamethylene diisocyanate, decamethylene diisocyanate, dodecamethylene diisocyanate, tetradecamethylene diisocyanate, trimethylhexane diisocyanate, tetramethylhexane diisocyanate, isophorone diisocyanate, 2-isocyanatopropylcyclohexyl isocyanate, dicyclohexylmethane 2,4′-diisocyanate, dicyclohexylmethane 4,4′-diisocyanate, 1,4- or 1,3-bis(isocyanatomethyl)cyclohexane, 1,4- or 1,3- or 1,2-diisocyanatocyclohexane, 2,4- or 2,6-diisocyanato-1-methylcyclohexane, diisocyanates derived from dimer fatty acids, of the kind sold under the commercial designation DDI 1410 by Henkel, 1,8-diisocyanato-4-isocyanatomethyloctane, 1,7-diisocyanato-4-isocyanatomethylheptane, or 1-isocyanato-2-(3-isocyanatopropyl)cyclohexane, isocyanatopropyl)cyclohexane, or tetramethylxylylene diisocyanates (TMXDI), or mixtures of these polyisocyanates. Preference here is given to using the dimers and/or trimers of the stated polyisocyanates, which are known per se—that is, then, more particularly, the uretdiones and ioscyanurates of the aforementioned polyisocyanates, especially of the aforementioned diisocyanates, that are known per se and are that are also available commercially.

Particular preference for the purposes of the present invention is given to using amino resins, among them preferably melamine resins and benzoguanamine resins, and also polycarbodiimides as crosslinking agents.

By amino resins are meant the polycondensates, known per se to the skilled person, of organic carbonyl compounds, more particularly formaldehyde, with amino derivatives of 1,3,5-triazine or urea. Generally speaking, the methylol groups formed in the course of this condensation are further etherified, proportionally or entirely, with alcohols such as methanol or butanol.

The preferred melamine resins are polycondensation resins of melamine (1,3,5-triazine-2,4,6-triamine) and a maximum of 6 mol of formaldehyde per mole of melamine. The resulting methylol groups may be wholly or partly etherified with one or a variety of alcohols such as, preferably, methanol and/or butanol. Melamine resins may have different degrees of methylolation and different degrees of etherification, and these parameters dictate in particular the reactivity of the resins, in other words, more particularly, the temperature at which effective crosslinking ensues through reaction with components such as, for example, polymers (A) as binders containing hydroxyl groups.

The degree of methylolation of a melamine resin describes how many of the possible methylolation sites of the melamine have been methylolated—in other words, how many of the total of six hydrogen atoms in the primary amino groups of the melamine (i.e., of the 1,3,5-triazine-2,4,6-triamine) have been replaced by a methylol group. A fully methylolated, monocyclic melamine resin, accordingly, has six methylol groups per triazine ring, such as hexamethylolmelamine, for example. The methylol groups may independently of one another be present in etherified form.

The degree of etherification of a melamine resin refers to the proportion of methylol groups in the melamine resin that have been etherified with an alcohol. In the case of a fully etherified melamine resin, all of the methylol groups present are etherified with an alcohol, rather than being free. Alcohols suitable for the etherification are monohydric or polyhydric. Monohydric alcohols are used with preference for the etherification. For example, methanol, ethanol, n-butanol, isobutanol, or else hexanol may be used for the etherification. Also possible is the use of mixtures of different alcohols, such as a mixture of methanol and n-butanol, for example.

Melamine resins may be monomeric (monocyclic) or oligomeric (polycyclic). The descriptor “monocyclic” or “polycyclic” refers to the number of triazine rings per molecule of melamine resin. An example of a monocyclic, fully methylolated, and fully butanol-etherified melamine resin is hexamethoxybutylmelamine.

Likewise used with preference are benzoguanamine resins. The description given for the melamine resins applies to these resins too, but the benzoguanamines differ from their melamine counterparts in that benzoguanamine is used instead of melamine. As a result of the phenyl ring which is present, correspondingly, in exchange for the amino group on the triazine ring, the reactivity of the resins is reduced and the pigment affinity is increased, something which in case of need may be an advantage. In this way, furthermore, the cured coating can be made water-repellent.

Use may be made, for example, of the products available commercially under the designations Cymel®, Resimene®, Maprenal®, and Luwipal®, such as Resimene® 747, Resimene® 755, Luwipal 066, and Cymel 1123.

Likewise used with preference as crosslinking agents are polycarbodiimides. These are the adducts which are known per se and contain repeating units containing diimide groups, of the formula [—R—N═C═N]ₙ, in which the groups R, independently of one another, are organic groups, such as aromatic groups, for example. They may be prepared, for example, by polymerization of corresponding diisocyanates, as for example toluene diisocyanate, using catalysts that are known per se. Use may be made, for example, of the products available commercially, such as Desmodur XP 2802 (Bayer) or Picassian XL-702 (Picassian Polymers).

The amount of crosslinking agents, more particularly polyisocyanates, melamine resins, benzoguanamine resins and/or polycarbodiimides, in the coating composition of the invention is preferably 0.5 to 10 wt %, especially preferably 1 to 8 wt %, very preferably 1.5 to 6 wt %, and, in one particular embodiment, 2 to 5 wt %, based in each case on the total amount of the coating composition of the invention.

The fraction of the crosslinking agent (B) is determined by a method analogous to that described above for the polymer (A) as binder, in other words on the basis of the solids content.

The coating composition of the invention comprises at least one specific polymer (C) as binder.

The polymer (C) as second binder is by definition of course a component that is different from the polymer (A) as binder and from the crosslinking agent (B). The at least one polymer (C) is a copolymer which is obtainable by copolymerization of ethylenically unsaturated monomers in the presence of a polyurethane resin having polymerizable carbon double bonds. Copolymers which can be used as second binder (C) are known from WO 91/15528 A, for example, and can therefore be easily prepared by the skilled person.

The polymer (C) used as binder preferably has a weight-average molecular weight of 2000 to 100 000 g/mol, more preferably of 5000 to 80 000 g/mol, very preferably of 15 000 to 60 000 g/mol, more particularly of 30 000 to 55 000 g/mol or of 35 000 to 50 000 g/mol.

The polymer (C) preferably has a number-average molecular weight of 100 to 50 000 g/mol, more preferably of 1000 to 40 000 g/mol, very preferably of 2500 to 25 000 g/mol, more particularly of 3000 to 20 000 g/mol or of 4000 to 15 000.

The polymer (C) preferably has an acid number of 5 to 200, more preferably of 10 to 150, very preferably of 15 to 100, more particularly of 20 to 50 or of 25 to 40 mg of KOH per g of binder (C).

The polymer (C) preferably has hydroxyl groups and has in particular an OH number (hydroxyl number) of 5 to 100, more preferably of 10 to 90, very preferably of 20 to 80, more particularly of 30 to 70 or of 40 to 60, mg of KOH per g of binder (C).

The polyurethane resin having polymerizable carbon double bonds for preparing the polymer (C) preferably has on average per molecule 0.05 to 1.1, preferably 0.2 to 0.9, more preferably 0.3 to 0.7 polymerizable carbon double bond(s). It is preferred for the polyurethane resin used to have an acid number of 0 to 2 mg of KOH per g of polyurethane resin. The skilled person is familiar with how such polyurethane resins can be prepared, this being described, moreover, in WO 91/15528 A, for example.

The polyurethane resin having polymerizable carbon double bonds for preparing the polymer (C) is obtainable preferably by reaction of at least one polyisocyanate with at least one polyol, more preferably at least one polyester polyol.

As polyisocyanate components here it is possible to use the polyisocyanates specified above in the description of the crosslinking agent (B). With particular preference, however, isophorone diisocyanate (IPDI) is used as polyisocyanate component for preparing the polyurethane resin on which the polymer (C) is based.

As polyol components, more particularly polyester polyol components, it is possible here to use, for example, the polyols specified above as part of a description of the polymer (A) (the components used in preparing polyesters (A)) and also the polyesters or polyester polyols themselves (that is, for example, polyesters (A) having free hydroxyl groups, in other words an OH number greater than 0).

Used with more particular preference as at least one polyester polyol is one which derives from at least one diol and/or triol selected from the group consisting of 1,6-hexanediol, neopentyl glycol, trimethylolpropane, and mixtures thereof, more particularly 1,6-hexanediol and neopentyl glycol, and from at least one dicarboxylic acid (or at least one dicarboxylic acid derivative thereof, such as a corresponding anhydride, for example) selected from the group consisting of adipic acid, terephthalic acid, isophthalic acid, ortho-phthalic acid, dimethylolpropionoic acid, and mixtures thereof, more particularly adipic acid.

Preferably at least one such polyester polyol with at least one polyisocyanate, more particularly with IPDI, is used for preparing the polyurethane resin on which the polymer (C) is based.

The at least one polyurethane resin used for preparing the polymer (C) has polymerizable carbon double bonds as reactive functional groups which allow a crosslinking reaction. These reactive functional groups are preferably selected from the group consisting of vinyl groups such as aryl groups and (meth)acrylate groups and also mixtures thereof. Particularly preferred are vinyl groups, preferably allyl groups, more particularly allyl ether groups.

In order to introduce the polymerizable carbon double bonds as reactive functional groups into the polyurethane resin when preparing the at least one polyurethane resin used in preparing the polymer (C), the polyurethane resin is prepared using not only the at least one polyisocyanate and the at least one polyol, such as preferably the at least one polyester polyol, but also at least one further polyol such as at least one monomeric diol which has at least one polymerizable carbon double bond as reactive functional group and, furthermore, has groups reactive toward NCO groups, specifically hydroxyl groups. At least one diol is used with preference as a monomer which also has at least one polymerizable carbon double bond as reactive functional group, more preferably a reactive functional group selected from the group consisting of vinyl groups such as allyl groups, allyl ether groups, and (meth)acrylate groups, and also mixtures thereof. Particularly preferred are vinyl groups, more particularly allyl ether groups. One such monomer used with preference is trimethylolpropane monoallyl ether. It is also possible for at least one polyol to be used, selected from the group consisting of glycerol monoallyl ether, pentaerythritol monoallyl ether and pentaerythritol diallyl ether, and mixtures thereof. Especially preferred, however, is trimethylolpropane monoallyl ether.

NCO groups still present in the resulting polyurethane segment may optionally be converted by reaction with at least one polyol such as trimethylolpropane until isocyanate groups are no longer detectable.

The polyurethane segment of the copolymer (C) may optionally be prepared by addition of at least one catalyst such as dibutyltin dilaurate. The preparation of the polyurethane segment of the copolymer (C) takes place preferably in an organic solvent such as methyl ethyl ketone (MEK), for example.

To prepare the copolymer (C), the at least one polyurethane resin obtained in this way and having polymerizable carbon double bonds is copolymerized in the presence of ethylenically unsaturated monomers.

Monomers used as ethylenically unsaturated monomers for preparing the polymer (C) are preferably selected from the group consisting of aliphatic and cycloaliphatic esters of acrylic acid or methacrylic acid ((meth)acrylates), ethylenically unsaturated monomers which carry at least one hydroxyl group in the molecule, preferably (meth)acrylates which carry at least one hydroxyl group in the molecule, ethylenically unsaturated monomers which carry at least one carboxyl group in the molecule, preferably (meth)acrylic acid, and mixtures thereof.

With particular preference the ethylenically unsaturated monomers are selected from the group consisting of cyclohexyl acrylate, cyclohexyl methacrylate, alkyl acrylates and alkyl methacrylates having up to 20 carbon atoms in the alkyl radical, such as, for example, methyl(meth)acrylate, ethyl(meth)acrylate, n-propyl(meth)acrylate, isopropyl(meth)acrylate, n-butyl(meth)acrylate, tert-butyl(meth)acrylate, n-hexyl(meth)acrylate, ethylhexyl(meth)acrylate, stearyl(meth)acrylate, and lauryl(meth)acrylate, or mixtures of these monomers, hydroxyalkyl esters of the acrylic acid and/or methacrylic acid such as 2-hydroxyethyl(meth)acrylate, 2-hydroxypropyl(meth)acrylate, 3-hydroxypropyl(meth)acrylate, 3-hydroxybutyl(meth)acrylate, and 4-hydroxybutyl(meth)acrylate, (meth)acrylic acid, ethanediol di(meth)acrylate, 1,4-butanediol di(meth)acrylate, 1,6-hexanediol di(meth)acrylate, trimethylolpropane tri(meth)acrylate, pentaerythritol di(meth)acrylate, and allyl(meth)acrylate.

Particular preferred ethylenically unsaturated monomers for preparing the polymer (C) are selected from the group consisting of n-butyl(meth)acrylate, methyl(meth)acrylate, 2-hydroxypropyl(meth)acrylate, 3-hydroxypropyl(meth) acrylate, (meth)acrylic acid, and mixtures thereof.

To initiate the copolymerization it is possible to use at least one initiator such as, for example, tert-butyl peroxy-2-ethyl hexanoate.

The copolymerization takes place preferably in an organic solvent such as methyl ethyl ketone (MEK), for example. The resulting copolymer (C) is preferably taken up in water and optionally neutralized with at least one neutralizing agent such as the neutralizing agents already specified above, more particularly dimethylethanolamine. The organic solvent such as MEK, for example, is removed again preferably after preparation of the copolymer (C), by means of distillative removal under reduced pressure, for example. A dispersion obtained in this way may retain a fraction of MEK, used when preparing the copolymer (C), that is at most in a range from 0.2 to 1.5 wt %, preferably of 0.2 to 1.0 wt % or of 0.2 to 0.6 wt %, based in each case on the total weight of the dispersion.

It follows from the above that the at least one polymer (C) as well is preferably a polymer dispersible or soluble in water. The potentially ionic groups, preferably anionic groups, more preferably carboxylic acid groups that are preferred or even necessary for this purpose according to elucidations above may be introduced into the polymer by the starting compounds used for the preparation, preferably by the ethylenically unsaturated monomers employed in the preparation. For instance, carboxylic acid groups are preferably incorporated into the copolymer (C) through the proportional use of acrylic acid when copolymerizing the polyurethane resin having polymerizable carbon double bonds, in the presence of ethylenically unsaturated monomers.

The amount of the at least one polymer (C) as second binder in the coating composition of the invention is preferably 0.1 to 8.0 wt %, especially preferably 0.1 to 7.5 wt %, very preferably 0.5 to 6.0 wt %, in one particular embodiment 0.8 to 5.0 wt %, and, even more preferably within this range, 1.0 to 4.0 wt %, based in each case on the total amount of the coating composition of the invention.

Determining the fraction of the at least one polymer (C) takes place in analogy to the method described above for the polymer (A) as binder and for the crosslinking agent (B), in other words on the basis of the solids content.

It is essential to the invention that the weight fractions of the at least one polymer (A) as binder and of the at least one polymer (C) as second binder are matched with one another such that the weight ratio of the polymer (A) to the polymer (C) is greater than 3.0, preferably greater than 5.0, very preferably greater than 7.5, and more particularly greater than 8.5. More preferred is a weight ratio of greater than 3.0 to 30, preferably, within this range, greater than 5.0 to 25, more particularly 7.5 to 20, and very preferably 8.5 to 15. The weight ratio is determined on the basis of the respective amounts or fractions of the two polymers (A) and (C), based on the total amount of the coating composition of the invention. The fractions of the polymers (A) and (C), relative to the total amount of the coating composition of the invention, are determined as indicated above via the solids content.

These amounts of the polymers (A) and (C) are preferably selected from the preferred fraction ranges indicated above, with care then being taken to ensure that operation takes place in the ratio range of the invention, preferably in the preferred ratio ranges.

It follows from the above more particularly that the coating composition always comprises the polymer (A) in a marked excess in relation to the polymer (C) and, moreover, comprises the polymer preferably not in excessive amounts, especially preferably only in additive amounts of not more than 4.0 wt %.

This means, therefore, that for the purposes of the present invention the binder (A) is used fundamentally as principal binder, whereas the polymer (C) may be considered more as an additive component or as a binder used only in minor amounts.

As a result of the above-described matching of the amounts of the polymers (A) and (C), it is possible to formulate a coating composition which meets the fundamental requirements of a composition for topcoat coating, more particularly in the sector of the coating of packaging containers, and which additionally guarantees significantly improved abrasion resistance in comparison to the prior art when a topcoat film of this kind is not completely cured.

The coating composition of the invention is aqueous. The expression “aqueous coating composition” is known to the skilled person. It refers in principle to a coating composition which is not based exclusively on organic solvents. Indeed, a coating composition of that kind, based on organic solvents, comprises exclusively organic solvents and no water for dissolving and/or dispersing further components, or is a composition prepared without explicit addition of water, with water instead entering the composition only in the form of an impurity, atmospheric moisture and/or solvent for specific additives that are optionally employed. Such a composition would—in contrast to an aqueous composition—be termed as solvent-based or as “based on organic solvents”.

“Aqueous” for the purposes of the present invention should be taken preferably to mean that the coating composition in question has a fraction of at least 20 wt %, preferably at least 25 wt %, very preferably at least 30 wt %, of water, based in each case on the total amount of the solvents present (that is, water and organic solvents). Preferably in turn, the fraction of water is 20 to 70 wt %, more particularly 25 to 60 wt %, very preferably 30 to 50 wt %, based in each case on the total amount of the solvents present. The coating composition may therefore indeed include organic solvents, but this fraction is significantly lower in comparison to conventional solvent-based systems, and the composition in any case includes water.

The coating composition of the invention preferably further comprises at least one pigment (D) as well.

A pigment of this kind is preferably selected from the group consisting of organic and inorganic, coloring and extending pigments and also nanoparticles. Examples of suitable inorganic coloring pigments are white pigments such as titanium dioxide, zinc white, zinc sulfide, or lithopone; black pigments such as carbon black, iron manganese black or spinel black; chromatic pigments such as chromium oxide, chromium oxide hydrate green, cobalt green, or ultramarine green, cobalt blue, ultramarine blue, or manganese blue, ultramarine violet or cobalt violet and manganese violet, red iron oxide, cadmium sulfoselenide, molybdate red or ultramarine red; brown iron oxide, mixed brown, spinel phases, and corundum phases, or chromium orange; or yellow iron oxide, nickel titanium yellow, chromium titanium yellow, cadmium sulfide, cadmium zinc sulfide, chromium yellow, or bismuth vanadate. Examples of suitable organic coloring pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments, or aniline black. Examples of suitable extender pigments or fillers are chalk, calcium sulfate, barium sulfate, silicates such as talc or kaolin, silicas, oxides such as aluminum hydroxide or magnesium hydroxide, or organic fillers such as textile fibers, cellulose fibers, polyethylene fibers, or polymer powders; for further details, refer to Rompp Lexikon Lacke and Druckfarben, Georg Thieme Verlag, 1998, pages 250 ff., “Fillers”. Examples of nanoparticles are selected from the group consisting of main-group and transition-group metals and compounds thereof, meaning that the nanoparticles consist of these elements and/or compounds. Preference is given to the main-group and transition-group metals from main groups three to five, from transitions groups three to six, and from transition groups one and two of the Periodic Table of the Elements, and also the lanthanides. Particular preference is given to using boron, aluminum, gallium, silicon, germanium, tin, arsenic, antimony, silver, zinc, titanium, zirconium, hafnium, vanadium, niobium, tantalum, molybdenum, tungsten, and cerium, more particularly aluminum, silicon, silver, cerium, titanium, and zirconium. The compounds of the metals are preferably the oxides, oxide hydrates, sulfates, or phosphates. Preference attaches to using silver, silicon dioxide, aluminum oxide, aluminum oxide hydrate, titanium dioxide, zirconium oxide, cerium oxide, and mixtures thereof, particular preference to using silver, cerium oxide, silicon dioxide, aluminum oxide hydrate, and mixtures thereof, very particular preference to using aluminum oxide hydrate, and more particularly boehmite. The nanoparticles preferably have a primary particle size <50 nm, more preferably 5 to 50 nm, more particularly 10 to 30 nm. Methods for determining the primary particle size are known to the skilled person. The primary particle size is determined preferably by means of transmission electronic microscopy (TEM). Particularly preferred pigments are titanium dioxide and/or zinc white, zinc sulfide and/or lithopone as at least one pigment (D). Especially preferred is the use of titanium dioxide.

Effect pigments, furthermore, may be used as optional pigments (D) present in the aqueous coating composition. A skilled person is familiar with the concept of effect pigments. Effect pigments more particularly are those pigments which impart optical effect or color and optical effect, more particularly optical effect. A corresponding division of the pigments may be made in accordance with DIN 55944. The effect pigments are preferably selected from the group consisting of organic and inorganic optical effect and color and optical effect pigments. They are more preferably selected from the group consisting of organic and inorganic optical effect or color and optical effect pigments. The organic and inorganic optical effect and color and optical effect pigments are more particularly selected from the group consisting of optionally coated metallic effect pigments, of optionally coated metal oxide effect pigments, of optionally coated effect pigments composed of metals and nonmetals, and of optionally coated nonmetallic effect pigments. The optionally coated metallic effect pigments, such as silicate-coated metallic effect pigments, for example, are more particularly aluminum effect pigments, iron effect pigments, or copper effect pigments. Especially preferred are optionally coated—such as silicate—coated, for example—aluminum effect pigments, more particularly commercially available products from Eckart such as Stapa® Hydrolac, Stapa® Hydroxal, Stapa® Hydrolux and Stapa® Hydrolan, most preferably Stapa® Hydrolux and Stapa® Hydrolan. The effect pigments used in accordance with the invention, more particularly optionally coated—such as silicate-coated, for example—aluminum effect pigments, may be present in any customary form known to the skilled person, such as a leaflet form and/or a platelet form, for example, more particularly a (corn)flake form or a silver dollar form. The effect pigments composed of metals and nonmetals are, more particularly, platelet-shaped aluminum pigments coated with iron oxide, of the kind described in, for example, European patent application EP 0 562 329 A2; glass leaflets coated with metals, more particularly aluminum; or interference pigments which comprise a reflector layer made of metal, more particularly aluminum, and which exhibit a strong color flop. The nonmetallic effect pigments are more particularly pearlescent pigments, especially mica pigments; platelet-shaped graphite pigments coated with metal oxides; interference pigments which comprise no metal reflector layer and have a strong color flop; platelet-shaped effect pigments based on iron oxide, having a shade from pink to brownish red; or organic liquid-crystalline effect pigments. For further details of the effect pigments that can be used in accordance with the invention, reference is made to Römpp Lexikon Lacke and Druckfarben, Georg Thieme Verlag, 1998, page 176, “Effect pigments”, and pages 380 and 381, “Metal oxide-mica pigments” to “Metal pigments”.

The pigment content of pigment (D) in the aqueous coating compositions used in accordance with the invention may vary very widely depending on the intended use and on the nature of the pigments and nanoparticles. The pigment content, based on the aqueous coating composition of the invention, is preferably in the range from 1.0 to 50 wt %, more preferably in the range from 5.0 to 45 wt %, very preferably in the range from 7.5 to 40 wt %, especially preferably in the range from 12.5 to 35 wt %, and more particularly in the range from 15 to 30 wt %.

The coating composition of the invention preferably comprises at least one specific epoxy resin ester (E). The addition of this epoxy resin ester, which is described in more detail hereinafter, may again lead, in preferred embodiments of the invention, to an improvement in the adhesion properties and to the minimization of the swelling behavior of the topcoat laminae produced by using the coating composition of the invention, especially in the context of the sterilizing and/or pasteurizing which is a fundamental requirement in the case of packaging containers.

The specific epoxy resin esters are polymers prepared initially using an epoxy resin.

Epoxy resins are known to the skilled worker. They are the polycondensation resins known per se that contain epoxide groups in the parent molecule. Preferably they are epoxy resins prepared by condensing bisphenol A and/or bisphenol F with epichlorohydrin, more particularly bisphenol A/epichlorohydrin resins. Along the chain, for example, these compounds contain hydroxyl groups, and at the ends they contain epoxide groups, in other words, therefore, precisely two epoxide groups per molecule. It is of course also possible for only single-sided reaction with epichlorohydrin to take place, meaning that ultimately there is only one epoxide group in the molecule. Depending on chain length (that is, degree of condensation) of the epoxy resins, there is a change in the capacity for crosslinking via the epoxide groups and/or via the hydroxyl groups. Whereas with increasing chain length or molar mass, the capacity for crosslinking by the epoxide groups falls, the crosslinking capacity via the hydroxyl groups rises as the chain length grows. The reason is that while the number of epoxide groups per molecule remains the same or is a maximum of two (two terminal epoxide groups), each condensation reaction generates a further hydroxyl group. The amount of epoxide groups is defined generally, and thus also in the context of the present invention, by way of the epoxide equivalent weight (EEW), this being the amount of resin in grams that contains one mole of epoxide groups. The higher the degree of condensation, therefore, the higher the EEW as well. To determine the EEW, the weight fraction of epoxide groups in the resin is ascertained (in accordance with DIN EN ISO 3001) and is converted accordingly using the known molar mass of the epoxide group (44 g/mol). The degree of condensation and hence the EEW may be controlled, as is known, through the stochiometry of the components used—that is, in particular, bisphenol A and/or bisphenol F and also epichlorohydrin. While with a molar 1:2 ratio (bisphenol A and/or bisphenol F to epichlorohydrin) the smallest representatives of the class of resin are obtained (bisphenol A diglycidyl ether, for example), a move is made, in the case of a mixing ratio tending toward 1:1, toward very long-chain resins, which have a correspondingly high EEW.

Preference for the purposes of the present invention is given to using epoxy resins, preferably bisphenol A/epichlorohydrin epoxy resins, having an EEW of less than 500. These are, for example, bisphenol A diglycidyl ether and/or only slightly longer-chain epoxy resins obtainable from bisphenol A and epichlorohydrin, which are then also hydroxy-functional. The expression “slightly longer-chain” should be understood as imposing an upward limit on the molecular weight such that the number-average molecular weight of the epoxy resins does not exceed a figure of preferably 1000 g/mol. Diepoxy resins are preferred, these being epoxy resins which contain an epoxide group at both chain ends. Such epoxy resins may be obtained, in the form for example of a solution or dispersion in organic solvents or water, from the company Cytec under the commercial designation Beckopox, or from the company Momentive under the commercial designation Epikote, for example.

For preparation of the epoxy resin esters (E), at least one epoxy resin, more particularly the epoxy resins described above, is reacted with at least one further component to form ester bonds. What this means is more particularly the following.

For example, epoxy resin esters employed with preference are preparable by using epoxy resins when preparing polyester-epoxy resins (for definition see below) as part of the alcohol component, for example. As already described above, indeed, epoxy resins generally include not only the terminal epoxide groups but also hydroxyl groups, and so may replace part of the alcohol component in the course of a polyester preparation. The carboxylic acids to be used in preparing the polyester-epoxy resins then react with these hydroxyl groups, ultimately forming a polyester-epoxy resin or an epoxy resin ester (E). A polyester-epoxy resin for the purposes of the present invention, therefore, is a specific polyester prepared using an epoxy resin.

It is likewise possible first to prepare a polyester containing carboxyl groups and then to react the epoxy resin in an epoxy/carboxy esterification reaction and also, optionally hydroxyl/carboxyl esterification reaction with the polyester.

It is of course also possible to react an epoxy resin both with a carboxyl-containing polyester and additionally with other monomeric and/or polymeric polyester reactants such as typical monomeric polyols and polycarboxylic acids, already referred to for the description of the binders (A), and also prepolymerized polyester diols. In this case, therefore, the epoxy resin esters (E) are prepared using both monomeric starting compounds and polymeric starting compounds.

The polyesters which can be used to prepare component (E) are subject, in terms of the reactants to be used and the preparation conditions to be used, to the description given for the preparation of the polyesters (A)—that is, more particularly, also the conditions that are known anyway to the skilled person for polyesterification reactions with corresponding reactants, such as polyols and polycarboxylic acids. For details and examples of suitable synthesis components, therefore, reference may be made to the above description of component (A). The disclosure there applies equally to the polyesters described here.

The same is true, of course, for the polyhydric organic monomeric polyols and polybasic organic monomeric carboxylic acids and for the prepolymerized polyester diols which are used as well as the epoxy resins for the preparation of polyester-epoxy resins.

The epoxy resin esters (E) are therefore prepared preferably by reaction of an epoxy resin, preferably a hydroxy-functional epoxy resin, with a carboxylic acid-containing polyester (e1) and/or with compounds (e2) selected from the group consisting of polyhydric organic polyols such as monomeric diols, triols, tetrahydric alcohols, or polyester diols, polybasic organic carboxylic acids such as dicarboxylic acids, hydroxycarboxylic acids, lactones, anhydrides of polycarboxylic acids such as anhydrides of dicarboxylic acids, and also, optionally, monocarboxylic acids and simple alcohols.

The stated compounds (e2) suitable for the polyester synthesis are preferably selected from the group consisting of monomeric diols, triols, tetrahydric alcohols, and polyester diols, dicarboxylic acids, hydroxycarboxylic acids, lactones, anhydrides of dicarboxylic acids, and also, optionally monocarboxylic acids and simple alcohols. The polyester (e1) is prepared preferably by reaction of the compounds (e2), especially preferably by reaction of the preferred compounds (e2).

In another preferred embodiment of the present invention, the epoxy resin esters are prepared using at least one component (e2a) selected from the group consisting of o-phthalic acid, isophthalic acid, benzoic acid, trimethylolpropane, pentaerythritol, dimer fatty acids, polypropylene glycol, and C₁₂ to C₂₄ fatty acids such as palmitic acid, stearic acid, oleic acid, linolic acid, and ricinolic acid.

According to statements made above, therefore, the aforementioned components (e2a) are integrated into the preparation process or reaction process preferably during the reaction of an epoxy resin with a carboxylic acid-containing polyester (e1) and/or with compounds (e2) selected from the group consisting of polyhydric organic polyols such as monomeric diols or polyester diols, polybasic organic carboxylic acids such as dicarboxylic acids, hydroxycarboxylic acids, lactones, anhydrides of polycarboxylic acids such as anhydrides of dicarboxylic acids, and also, optionally, monocarboxylic acids and simple alcohols. This means, accordingly, that the carboxylic acid-containing polyester (e1) is prepared preferably with at least proportional use of the aforementioned components (e2a), and/or the aforementioned compounds (e2) which are used with preference for the reaction with an epoxy resin, in order to prepare an epoxy resin ester (E), are selected at least proportionally from the group of the components (e2a).

It is preferred, furthermore, for epoxy resin esters (E) to contain phosphorus. Phosphorus-containing epoxy resin esters (E), more particularly those which, as described above, are prepared by reaction of epoxy resins with polyesters (e1) and/or with compounds (e2) suitable for polyester synthesis, result in particularly good properties in terms of adhesion and minimizing the swelling behavior of corresponding topcoat films.

This phosphorus is incorporated preferably in the form of phosphate groups into the epoxy resin esters. Particularly the phosphate groups are introduced by reaction of the epoxy resins used in preparing the epoxy resin esters (E) with phosphoric acid, and corresponding esterification. In this reaction, therefore, which is known per se, the epoxide groups of the epoxy resins are reacted with the phosphoric acid, then forming a phosphoric ester. The epoxy resins phosphate-modified in this way are then reacted as described above, to form the epoxy resin esters (E).

Preference, therefore, is given to epoxy resin esters (E) prepared using phosphate-modified epoxy resins and/or phosphate group-containing epoxy resins.

The epoxy resin esters (E) used with preference preferably have an epoxy resin fraction, this being a fraction of epoxy resins as described above and optionally also phosphate-modified epoxy resins, of 40 to 90 wt %, preferably 50 to 75 wt %. The fraction is determined, as described above, via the solids content. This means that, as described above, the solids content of the epoxy resins (and/or epoxy resin dispersions) used, and of the further starting products, more particularly of components (e1) and (e2), is ascertained, and then the fraction in the epoxy resin ester (E) is ascertained by backward calculation, taking account of the quantities used.

The phosphorus content of the epoxy resin esters is preferably 0.5 to 3 wt %, more preferably 1 to 2.5 wt %. The amount may be determined arithmetically, for example, by taking account of the amounts of starting materials used when introducing the phosphorus, in other words, more particularly, of the epoxy resins and of the phosphoric acid, on the assumption of a quantitative conversion.

The epoxy resin esters (E) typically have a number-average molecular weight of 1000 to 3000 g/mol, preferably of 1500 to 2500 g/mol, and an acid number of 30 to 90 mg KOH/g, preferably of 35 to 50 mg KOH/g. The OH number is typically between 100 and 260 mg KOH/g, preferably between 160 and 200 mg KOH/g.

The amount of the at least one epoxy resin ester (E) in the coating composition of the invention is preferably 0.5 to 8.0 wt %, especially preferably 0.8 to 7.0 wt %, very preferably 1.0 to 6.0 wt %, in one particular embodiment 1.5 to 5.0 wt %, and, in turn, more preferably 2.0 to 4.0 wt %, based in each case on the total amount of the coating composition of the invention. The amount is determined as described above for the solids content.

The coating composition used in accordance with the invention may, depending on its desired application, comprise one or more typically used additives, different from the above-described components (A) to (E), as component (G). These additives (G) are preferably selected from the group consisting of waxes, antioxidants, antistats, wetting and dispersing agents, emulsifiers, flow control assistants, solubilizers, defoaming agents, wetting agents, stabilizing agents, preferably heat stabilizers and/or thermal stabilizers, in-process stabilizers and UV stabilizers and/or light stabilizers, photo protection agents, deaerating agents, inhibitors, catalysts, flexibilizers, flame retardants, organic solvents such as, for example, butyl glycol and/or butyl glycol acetate, reactive diluents, water repellents, hydrophilizing agents, thickeners, thixotropic agents, impact modifiers, expandants, process aids, plasticizers, fibrous solids, and mixtures of the aforementioned additives. The amount of additive (G) in the coating composition of the invention may vary very widely, depending on the intended use. The amount, based on the total weight of the coating composition used in accordance with the invention, is preferably 0.01 to 25.0 wt %, more preferably 0.05 to 15.0 wt %, very preferably 0.1 to 10.0 wt %.

The solids content of the coating composition of the invention is preferably from 10 to 85 wt %, more preferably 15 to 80 wt %, very preferably from 20 to 75 wt %, and more preferably 40 to 70 wt %. The solids content of the coating composition of the invention is determined as described above.

The coating composition of the invention can be prepared by mixing and dispersing and/or dissolving the respective components of the coating composition that have been described above, using high-speed stirrers, stirred tanks, agitator mills, dissolvers, compounders, or inline dissolvers.

Further provided by the present invention is a method for producing a topcoat on a metallic substrate using the coating composition of the invention, comprising applying and subsequently curing the coating composition of the invention on an optionally primed metallic substrate.

Metallic substrates contemplated ultimately include all metals or substrates that are known in this context to the skilled person. Employed more particularly, however, are the metallic substrates used in the packaging coating sector, in other words, preferably, tinplate sheets, chromed steel sheets, and aluminum.

These substrates may inherently have any desired form. For example, they may be metallic substrate plates which after coating, for example, may be shaped into three-dimensional structures. Likewise possible, however, is the coating of already fully formed shaped structures in the context of the method of the invention. It is equally possible for preformed three-dimensional shaped structures in cylindrical form to be coated, these structures being those which subsequently, after coating, are formed in more detail into cans such as beverage cans or preserve cans. The latter variant in particular, in which the preformed and subsequently coated shaped structures are then subjected to detail forming, by the aforementioned necking, for example, is often encountered in the packaging coating sector, and is preferred accordingly. Particularly preferred substrates are therefore packaging systems, more particularly thus packaging containers, preferably food packaging.

Prior to the application and curing of the coating composition of the invention for the purpose of producing a topcoat, the metallic substrate may be pretreated and/or primed and/or coated, for example, with a typical stamping coat or priming varnish (that is, application and curing of the—for example—stamping coat or priming varnish), in accordance with known and established techniques. Stamping varnish, as is known and hence also in the context of the present invention, refers to a pigmented coating material which is coloring or white, preferably white, and thus comprises corresponding pigments. It is hiding—that is, it masks the underlying substrate and serves more particularly for decorative properties, and permits printability with printing inks and also promotion of adhesion for the topcoat. The priming varnish, as is known and hence also for the purposes of the present invention, refers to a coating material which comprises no pigments, or exclusively or predominantly transparent pigments, and therefore does not mask the substrate like the stamping varnish. Otherwise, however, the priming varnish also fulfills the functions according to the stamping varnish—that is, in particular, the promotion of adhesion and the mediation of printability. Priming compositions and priming-coat and/or stamping-varnish systems are known to the skilled person and can be selected without problems. It follows from the statements above that it is likewise possible for the substrate to be printed with printing inks, in the form of an indicium or the like, for example, after a coating material of this kind, pigmented for example, has been applied and cured. Then, thereafter, the coating composition of the invention may be applied and cured as described later on below, for the purpose of producing a topcoat.

A particular advantage of the present invention, however, is that even without prior coating with a varnish such as stamping varnish or priming varnish, preferably without any priming and without prior varnishing with a varnish such as stamping varnish or priming varnish, a coated substrate can be produced, with the coating composition of the invention, that fulfills the requirements identified at the outset. Particularly noteworthy are good decorative properties such as coloring, and at the same time good printability, and also, in particular, a significantly improved abrasion resistance on the part of the corresponding coating, particularly in the case of the coating when it is not yet fully cured.

In the context of the method of the invention, therefore, the coating material of the invention is preferably applied directly to the substrate and then cured, and in this way a topcoat film is produced. This means, therefore, that as part of the method of the invention a single-coat coating is preferably produced. The coating produced from the coating composition of the invention is therefore the sole coating film of the coating. All that are applied to this coating thereafter are, optionally, printing inks that give the substrate—the beverage can, for example—a particular decoration, but do not constitute a coating in the sense of the present invention.

Application of the coating composition of the invention takes place in the manner familiar to the skilled person and may be accomplished, for example, by rolling, dipping, knifecoating, spraying such as, for example, by means of compressed-air spraying, airless spraying, high-speed rotation, electrostatic spray application (ESTA), optionally in conjunction with hot spray application such as hot air (hot spraying), for example. Roll processes are preferred.

Following application, the applied coating composition is cured. By curing, more precisely complete curing, is meant the terminological content that is familiar to the skilled person. Accordingly, curing, more precisely complete curing, of a coating film is understood to be the conversion of such a film into the ready-to-use state, in other words, therefore, into a state in which the substrate furnished with the respective coating film may be transported, stored, and put to its intended use. A cured coating film, then, is in particular no longer soft or tacky, but is instead conditioned as a hard coating film. Its properties such as hardness, adhesion to the substrate, or abrasion resistance, are no longer improved even on further exposure to curing conditions like those described later on below. In this condition, therefore, even by further exposure to curing conditions as described below, the crosslinking structure of the coating film can no longer be increased, and the strength of the coating means that any reactive complementary functional groups still present in the components such as polymers as binders and crosslinking agents are no longer mobile and, accordingly, no longer available for the further curing reaction. On the contrary, in fact, further exposure to curing conditions like those described later on below may be accompanied by a degradation of the network, and so as a result it is even possible for the inherently advantageous properties of the coating to deteriorate again.

Complete curing may take place preferably at a temperature between 150 and 450° C. for a time of from 10 to 1800 seconds. Corresponding combinations of curing temperatures and curing times are familiar to the skilled person or can be ascertained by a few goal-directed experiments. For example, complete curing may proceed at 400° C. for 60 to 180 seconds or at 230° C. for 300 to 600 seconds.

The temperatures stated should be understood in each case to be oven temperatures, in other words as the ambient temperature in the space within which the coated substrate is cured.

A very particular advantage of the present invention, however, is that a coating produced on a substrate using a coating composition of the invention exhibits significantly improved abrasion resistance in comparison to the prior art, even without complete curing. As described at the outset, this enables an optimum energy balance during the production process, in spite of corresponding mechanical loading of the coated substrates during said production. In particular, packaging containers produced in a process involving sequential application of coating compositions and printing inks and heating for the purpose of (optionally in each case partial) curing can be produced advantageously in this way. The printability can be improved in this way as well.

Accordingly, then, for example, only partial curing is achieved when—in relation to a particular coating composition—the coated substrate is treated at lower temperatures and/or for shorter times than required for complete curing. These circumstances as well can be adapted by the skilled person in a simple way and according to the particular case in hand. For example, only partial curing may proceed at 400° C. for 2 to 15 seconds or at 230° C. for 60 to 240 seconds.

In the sense of this advantageous energy balance and improved printability, the method of the invention, in one preferred embodiment, accordingly, relates to the following steps. Application of a coating composition of the invention to a metallic substrate and subsequent incomplete curing of the applied coating composition, sequential application of one or more further coating compositions and/or printing inks to the substrate and/or to the coating, not fully cured, of the coating material of the invention, the coated substrate being exposed to curing conditions after each application, i.e., treated for a time of, for example, 2 to 15 seconds at 400° C. The consequential sequential curing conditions here are selected such that after the last exposure of the coated substrate with curing conditions, all of the applied coating compositions and printing inks are cured. Exposure to curing conditions, accordingly, is not necessarily synonymous with the fact that the coating present thereafter is fully cured. It is therefore possible, in particular, for a partially cured coating to result as well, and to be fully cured only in a further curing step, in other words during further exposure to curing conditions. Preferably only printing inks are applied to the coating produced by application of the coating composition of the invention. Therefore, further coating compositions, more particularly varnishes or primers, are applied preferably only to the metallic substrate or are applied to one another in the form of a multicoat system, with the first of these layers in that case being disposed on the substrate. In the case of a planar substrate, therefore, the side of the substrate in question is the second flat side of the substrate. In the case of a packaging container, more particularly a beverage can, the coating material of the invention is used preferably to produce an exterior coating. Further varnishes and/or primers are therefore applied preferably only to the inside of the substrate. Printing inks only are preferably disposed on the outside or on the topcoat of the invention.

With the varnish systems of the invention, more particularly single-coat varnish systems, the topcoat that is produced using the coating composition of the invention generally has a dry film thickness of preferably 2 to 12 micrometers, especially preferably from 3 to 10 micrometers, and very preferably 4 to 8 micrometers.

The present invention also relates to a topcoat produced by the method of the invention, and to a metallic substrate coated in accordance with the method of the invention. The present invention accordingly also provides in particular a metallic substrate coated with a single-coat coating, the coating being produced by using a coating composition of the invention.

### EXAMPLES

a) Preparation of Coating Compositions

The coating compositions C1 (comparative) and I1 (inventive) specified in more detail in table 1 were each produced with stirring and mixing by means of a dissolver. In this case, the components identified in table 1 were combined in the manner and order indicated therein. Table 1 also reports the solids content (NVC) of the components (where 1=100%).

TABLE 1
Coating compositions C1 and I1

| | | | Amount | |
|---|---|---|---|---|
| | | | used | |
| | | | in parts | |
| | | NVC | by weight | |
| Component | | (Component) | C1 | I1 |
| Weigh out in list order | | | | |
| Uradil CP 4707 | Polymer (A), polyester with | 0.73 | 27.59 | 27.6 |
| | OH number = 122 mg KOH/g, | | | |
| | acid number 45 mg KOH/g, | | | |
| | Mn = 800 g/mol, Mw = 1800 g/mol | | | |
| | in butyl glycol | | | |
| Luwipal_066 _LF | Crosslinking agent (B), melamine resin | 0.99 | 1.24 | 1.24 |
| Plastigen G | Plasticizer | 0.98 | 1.87 | 1.87 |
| Cymel_1123 | Crosslinking agent (B), | 0.99 | 3.38 | 3.38 |
| | Benzoguanamine resin | | | |
| Resydrol_AX_247W | Polymer (A), epoxy-functional resin | 0.7 | 2.51 | 2.51 |
| Titanium dioxide RDI-S | White pigment (D) | 1 | 25.11 | 25.12 |
| Shamrock SST 3H | Wax | 1 | 0.94 | 0.94 |
| 5 min. dissolver treatment | | | | |
| at ~1500 rpm, temp. | | | | |
| max 50° C., thereafter | | | | |
| continue weighing out | | | | |
| with dissolver treatment | | | | |
| Amino alcohol 2M-ABS | | 0.00 | 1.8 | 1.8 |
| (DMEA) | | | | |
| Urad DD 79 | Phosphate group-containing | 0.73 | 4.21 | 4.21 |
| | epoxy resin ester (E) | | | |
| Municipal water | | 0.00 | 11.56 | 11.56 |
| Lubaprint HLT 626 | Wax dispersion | 0.14 | 1.9 | 1.9 |
| Byketol_WS | Flow control additive | 0.04 | 2.08 | 2.08 |
| 5 min. dissolver treatment | | | | |
| at ~1500 rpm. temp max. | | | | |
| 50° C., thereafter continue | | | | |
| weighing out with dissolver | | | | |
| treatment | | | | |
| Additol XW 395 | Wetting additive | 0.5 | 0.94 | 0.94 |
| Byk 381 | Flow control agent | 0.52 | 0.07 | 0.07 |
| Butyl diglykol acetate | Solvent | 0 | 8.18 | 8.18 |
| Nacure_2500 | Catalyst | 0.43 | 0.94 | 0.94 |
| Aqueous dispersion of a | From WO 91/15528 A1, page 23, | 0.44 | 0 | 4.68 |
| copolymer (C) | line 26 to page 24, line 24, | | | |
| | with NVC adjusted to 0.44 | | | |
| Varsol 60 | Organic solvent | 0 | 1 | 1 |
| 10 min. dissolver treatment | | | | |
| at ~1500 rpm, temp. max. | | | | |
| 40° C., then leave with | | | | |
| stirring overnight | | | | |
| in the container carriage. | | | | |
| | | | 95.34 | 100 |

b) Production of Topcoats and Performance Investigation of the Coatings

The coating compositions prepared under a) were applied by roll application to iron cans (0.33 liter) in a coat add-on of 280 to 320 mg/can (corresponding to a film thickness of 5-6 micrometers).

The coated substrates were then exposed to a temperature of 230° C. in a forced air oven for 3 minutes. The partially cured topcoats (B-C1) and (B-I1) thus produced were then investigated for different performance properties.

The abrasion resistance was investigated by means of the DIN EN 13523-11 MEK test. A piece of cotton compress (Art. No. 1225221 from Romer Apotheke Rheinberg) is fastened with a rubber band to the head of an MEK hammer and then impregnated with MEK (methyl ethyl ketone). The hammer weighs 1200 g and has a handle with a placement area of 2.5 cm². The hammer is likewise filled with solvent, which runs continuously into the cotton compress. This guarantees that the compress is dripping wet throughout the test. A metal test panel is rubbed once back and forth with the compress, this panel being like the test panels employed above (=1 DR one double rub). The test distance here is 9.5 cm. One DR here is to be performed in 1 s. During this procedure, no additional force is exerted on the hammer. The top and bottom points of reversal at the edges of the metal test panel are not evaluated. A count is made of the DRs needed in order to erode the entire coating film on the metal test panel down to the substrate.

The larger the number of double rubs required, the higher the stability of the coating film relative to the influence of the mechanical stress through the hammer, with the MEK further specifically increasing the stress. In this way a statement is obtained that can be correlated with the mechanical abrasion resistance. The results (number of DRs) are shown in table 2.

Also investigated was the gloss, the stability to development of popping marks, and the leveling of the partially cured topcoats, these investigations taking place by visual means. This visual investigation was made from different viewing angles under different light conditions, in order to give a representative impression of the surface quality. Table 2 shows the corresponding results.

TABLE 2
Results of performance investigations

| | | | | Abrasion |
|---|---|---|---|---|
| | | | | resistance |
| | | | | (MEK, number |
| | Gloss | Popping | Leveling | of DRs) |
| (B-C1) | sat. | sat. | sat. | 1 |
| (B-I1) | sat. | sat. | sat. | 2 |

The results show clearly that the abrasion resistance of the as yet uncured topcoat produced using the coating composition of the invention is improved relative to the prior-art system. At the same time it is apparent that through the deliberate tailoring of the amounts of the components present, more particularly the amounts of the polymers (A) and the copolymers (C), the fundamentally important properties of the coating in terms of gloss, leveling, and stability toward popping (sat.=satisfactory) were fully preserved.

1. An aqueous coating composition, comprising
(A) at least one polymer as a first binder,
(B) at least one crosslinking agent, and
(C) at least one copolymer as a second binder, which is obtainable by copolymerization of ethylenically unsaturated monomers in the presence of a polyurethane resin having polymerizable carbon double bonds,
wherein
a weight ratio of the polymer (A) to the polymer (C) is greater than 3.0.

2. The aqueous coating composition as claimed in claim 1, wherein the weight ratio of the polymer (A) to the polymer (C) is greater than 5.0.

3. The aqueous coating composition as claimed in claim 1, wherein a weight ratio of the polymer (A) to the polymer (C) is greater than 5 to 25.

4. The aqueous coating composition as claimed in claim 1, wherein at least one hydroxy-functional polyester is present as the polymer (A).

5. The aqueous coating composition as claimed in claim 4, wherein at least one hydroxy- and carboxy-functional polyester is present as the polymer (A) and said at least one polyester makes up at least 80 wt % of the polymers (A) used as the first binder.

6. The aqueous coating composition as claimed in claim 1, wherein the at least one crosslinking agent (B) is selected from the group consisting of a polyisocyanate, a melamine resin, a benzoguanamine resin, a polycarbodiimide, and a mixture thereof.

7. The aqueous coating composition as claimed in claim 1, further comprising:
(D) at least one pigment.

8. The aqueous coating composition as claimed in claim 1, wherein a fraction of the polymer (A) as binder is 5 to 35 wt % and a fraction of the copolymer (C) is 0.1 to 8.0 wt %, based in each case on a total amount of the coating composition.

9. The aqueous coating composition as claimed in claim 1, wherein the polyurethane resin used for preparing the copolymer (C) has allyl ether groups as polymerizable carbon double bonds, and the copolymer (C) has hydroxyl groups.

10. The aqueous coating composition as claimed in claim 1, further comprising:
(E) at least one epoxy resin ester which is preparable by reaction of a hydroxy-functional epoxy resin with a carboxylic acid-containing polyester (e1) and/or with at least a compound (e2) selected from the group consisting of a polyhydric organic polyol, a polybasic organic carboxylic acid, a lactone, an anhydride of a polycarboxylic acid, and optionally, a monocarboxylic acid and a simple alcohol.

11. The aqueous coating composition as claimed in claim 10, wherein the hydroxy-functional epoxy resin comprises a phosphate group.

12. A method for producing a topcoat on a metallic substrate, the method comprising
applying and subsequently curing the coating composition as claimed in claim 1 on the metallic substrate.

13. A topcoat produced by the method as claimed in claim 12.

14. A coated metallic substrate coated by the method as claimed in claim 12.

15. The coated metallic substrate as claimed in claim 14, wherein the topcoat is single-coat.
